(19) United States
(12) Patent Application Publication
(10) Pub. No.: US 2015/0373145 A1
(43) Pub. Date: Dec. 24, 2015

(54) METHOD FOR SELECTING THE REPRESENTATION OF THE SEGMENTS OF A MULTIMEDIA CONTENT TRANSMITTED OVER A COMMUNICATION NETWORK

(71) Applicant: ORANGE, Paris (FR)

(72) Inventors: Bertrand Berthelot, Bourgbarre (FR); Patrice Houze, Rennes (FR)

(21) Appl. No.: 14/764,951

(22) PCT Filed: Jan. 28, 2014
(86) PCT No.: PCT/FR2014/050155

§ 371 Date: Jul. 30, 2015

(30) Foreign Application Priority Data
Feb. 13, 2013 (FR) 1351239

(51) Int. Cl. H04L 29/08

(52) U.S. Cl. CPC H04L 67/32; H04L 67/02

(57) ABSTRACT

The invention relates to a method for managing the representation of the data segments (0.mp4v, 180180.mp4v) of a content received by a terminal from a server. Said method comprises a step (ET2) of producing a document from which universal addresses are generated, a representation of the segment in question selected by the terminal from a plurality of representations described in the document being associated with an address, the segment being able to be received from the server according to the selected representation. The method comprises the following steps on the terminal: a first step of transmitting an access inquiry to a first segment according to a first selected representation; a first step of receiving a response to the inquiry including a request for the modification of the first representation; a second step of transmitting an access inquiry to the first segment according to a second representation; and a second step of receiving the first segment from the server according to the second representation.

### TECHNICAL DOMAIN

The invention pertains to a method for selecting the representation of the segments of a multimedia content transmitted over a communication network.

Multimedia content is intended to mean any audio or video content, or more generally any other digital content.

The invention relates more specifically to the transmission and the reception of multimedia contents over a network, in particular the continuous downloading, also called streaming, of multimedia contents over a network.

It relates more precisely to a communication using universal addresses of contents.

It applies in particular to any client terminal (hereinafter simply called a terminal) capable of communicating over a telecommunications network in order to access a multimedia content via a universal address, also called a URI (standing for Uniform Resource Identifier).

Representation of a content is here intended to mean a particular way of creating a data stream representative of a content. A data stream created with an encoding bitrate is an example of a particular representation of the content.

### PRIOR ART

To access a multimedia content, a client terminal generally resorts to a universal address, or URI. Such an address provides at one and the same time access to the content and indications about the associated protocol for consuming it (consuming is understood to mean for example, in the case of a video content, downloading/receiving the content and thereafter optionally decoding it, and then viewing it).

A URI address is a string of characters identifying a physical or abstract resource. The syntax of a URI address complies with a set of standards enacted by the IETF (Internet Engineering Task Force), and in particular specification RFC 3986 (specification: Uniform Resource Identifier (URI): Generic Syntax). A universal address such as this will take for example the form dvb://content1, rtsp://content2, HTTP://content3, ftp://content4, etc.

Access to the multimedia content is triggered by a request, through a URI address. A conventional illustration thereof is an on-demand video service: a first step consists for the terminal in downloading a document describing the parameters for access to the service (SDP for Session Description Protocol) via an HTTP (Hyper Text Transport Protoco protocol, a client-server communication protocol developed for Internet networks and in particular the Web;
during a second step, the service actually commences, that is to say that the dient terminal can receive and display the video, by virtue of the information provided in the document (in this example, the SDP). It will be noted that this document may be a computer file or a set of information descriptive of the content accessible at a certain address.

Hereinafter, the expression “description file” or “document” will be employed according to the context. It will be noted that this type of access to the service may require the presence of a server (in particular in the case of a point-to-point or “unicast” communication) or may not (in the case of a point to multipoint communication of “broadcast” or “multicast” type). In particular, the HTTP protocol is of point-to-point (“unicast”) type, and therefore involves the presence of a server so as to process the request of a client, a so-called HTTP client.

It is frequent, in this context of the HTTP protocol, to resort, in order to exchange data between the client and the server, to a technique of “HTTP adaptive streaming” type. This type of technique makes it possible in particular to offer a good user experience while taking account for example of the bandwidth variations on the link between the client terminal and the content server. Conventionally, various qualities can be encoded for the same video, corresponding for example to various bitrates. Each bitrate is itself sliced into temporal segments (or “fragments” of content). The description of these various bitrates and of the segmentation, as well as the fragments of content, are made available to the client terminal on a service platform. To be able to access the complete content, it is therefore necessary to know numerous addresses (URI) corresponding to multiple segments.

There exist several solutions for facilitating the distribution of such a content in streaming mode. These schemes propose that one or more intermediate description files, also called documents, or manifests, or else resources, containing the addresses of the various segments at the various qualities of the multimedia content, be addressed to the client. The basic principle of these schemes is to make available contents with various bitrate variants, each of the variants being available in the form of contiguous segments of media data which are downloadable by the clients with the aid of the HTTP protocol.

The reading of a content according to the “HTTP adaptive streaming” technique for a given client terminal consists in:
downloading and analyzing the description document which gives the description of the content, the variants of bitrates available, and the means of accessing the data segments for each bitrate variant;
downloading the data segments, and for each segment selecting a particular representation, in particular selecting a bitrate for encoding the segment to be downloaded;
and then analyzing and bundling the data segments so as to decode them In order to read the content.

There exist two modes of selection (or of adaptation) of the representation of the segments.

According to a first mode, the selection is the responsibility of the client terminal. In this mode, it is up to the client terminal to select the representation for each segment of media data as a function of parameters internal to the client (e.g.: measured bandwidth, capabilities of the terminal, etc.); in particular, the client terminal selects for each segment a given encoding bitrate. If the bandwidth measured by the client is sufficient, the client will usually select a high encoding bitrate. However, the fact of leaving the adaptation decision solely to the client prevents the content distributor from having mastery of its platform (servers), of its network, and of the services. The major risk for the distributor is of having to serve too high a number of requests for access to the segments with a high encoding bitrate. The consequence would be saturation of the network bandwidth or of the HTTP servers. This may also result in a drop in the quality of playback on the client terminal, manifested for example by image freezes.

According to a second mode, the selection is the responsibility of the server that broadcasts (or distributes) the content over the network. In this configuration, a solution consists of inserting, into the data of a broadcast segment, an item of information relating to a demand for modification of the representation, for example a demand for a decrease in the encoding bitrate. The Information can be included in a field named “Event”, described in the MPEG DASH standard. MPEG DASH (for Dynamic Adaptive Streaming over HTTP—ISO/IEC standard 23009-1:2012(E)) of the ISO/IEC normalization organization dedicated to the streaming of multimedia contents over the Internet; the problem related to this second mode is the reaction time to implement the adaptation client side. Indeed, the client receives a data segment in full, analyzes it in full before taking cognizance the new manifest including a demand for modification of the representation of the segments. The problem is that the manifest, which includes the modification demand, is not taken into account for the current segment received in the same stream as the modification demand. Consequently, this solution involves not only an operation of extracting the new manifest in the segment received, but also a playback of the segment received with poor quality.

The invention offers a solution not exhibiting the drawbacks of the prior art.

The Invention

For this purpose, according to a functional aspect, a subject of the invention is a method for managing the representation of the data segments of a content received by a terminal from a server, the method comprising a step of obtaining a document on the basis of which are generated universal addresses, with an address there being associated a representation of the segment concerned, chosen by the terminal from among several representations described in the document, the segment being able to be received from the server according to the chosen representation, characterized in that it comprises the following steps at the level of the terminal:
a first step of transmitting a request for access to a first segment according to a first chosen representation,
a first step of receiving a response to the request including a demand for modification of the first representation;
a second step of transmitting a request for access to the first segment according to a second representation;
a second step of receiving from the server the first segment according to the second representation.

Thus, the representation of the segments transmitted by the server is always a representation desired by the server. If a segment is received with a representation which is not a representation desired by the server, the latter, instead of transmitting the segment concerned, requests the client terminal, by way of the modification demand, for a retransmission from the terminal of a segment with another representation. The server receives the URI address with the new desired representation; it is only at that moment that the server transmits the segment concerned to the terminal with the new representation.

The modification demand envisaged hereinabove is transmitted in a distinct message from the data stream which conveys the segments. There is therefore no impact on the quality of the segments received.

Hence, with reference to a solution employed in the prior art, the invention avoids the analysis of a data stream containing the data segments in order to extract a new description file therefrom.

According to a first embodiment, a representation includes an encoding bitrate value for the segment. In this configuration, the first and the second representation include different values.

According to a second embodiment, the demand for modification of the first representation is taken into account by the terminal for a given duration. The fact, for the terminal, of taking into account the modification demand for a given time interval, avoids the contents server sending a modification demand several times in succession.

According to a third embodiment, the modification demand is transmitted according to the HTTP protocol. This characteristic avoids complete updating of the description file. The use of the HTTP protocol allows fast writing of the modification demand. The segments being transmitted for example every seconds by the server, this characteristic avoids a wait for a new manifest whose frequency of transmission from the server is more considerable, generally 30 seconds. More particularly, the demand is an http message comprising a digital code of the type defined in RFC standard 2616. The digital code is received by the client terminal which deduces therefrom by virtue of a correspondence table an item of information, In our example a setting related to the representation of a segment.

According to a hardware aspect, the invention deals with a terminal able to receive segments of a content, the terminal having access to a document on the basis of which are generated universal addresses, with an address there being associated a representation of a segment concerned, chosen by the terminal from among several representations described in the document, characterized in that it comprises
a first module for transmitting a request for access to a first segment according to a first chosen representation,
a first module for receiving a response to the request including a demand for modification of the first representation,
a second module for transmitting a request for access to the first segment according to a second representation;
a second module for receiving from the server the first segment according to the second representation.

According to another hardware aspect, the invention deals with a computer program comprising code instructions which, when the program is executed by a processor, carries out the steps defined hereinabove. The invention also deals with the recording medium readable by a terminal on which this program is recorded.

According to another functional aspect, the invention deals with a method for sending segments of a content according to a given respective representation, characterized in that it comprises
a first step of receiving a request for access to a first segment according to a first chosen representation,
a first step of transmitting a response to the request including a demand for modification of the first representation;
a second step of receiving a request for access to the first segment according to a second representation;
a second step of sending from the server the first segment according to the second representation.

According to another functional aspect, the invention deals with a computer program comprising code instructions which, when the program is executed by a processor, carries out the steps defined in the method of sending described hereinabove. The invention also deals with the recording medium readable by a server on which this program is recorded.

According to another hardware aspect, the invention deals with a server able to send segments of a content over a network, characterized in that it comprises
a first module for receiving a request for access to a first segment according to a first chosen representation,
a first module for transmitting a response to the request including a demand for modification of the first representation;
a second module for receiving a request for access to the first segment according to a second representation;
a module for transmitting from the server the first segment according to the second representation.

The Invention will be better understood on reading the description which follows, given by way of example and with reference to the appended drawings.

### THE FIGURES

FIG. 1 represents a streaming architecture based on the use of the over the Internet HTTP protocol according to an embodiment of the invention.

FIGS. 2 and 3 represent the circuits of the equipment involved in the method of the invention.

FIG. 4 represents a timechart according to an embodiment of the invention.

FIG. 5 also represents a timechart illustrating a variant of the embodiment described with reference to FIG. 4.

### DETAILED DESCRITION OF AN EXEMPLARY EMBODIMENT ILLUSTRATING THE INVENTION

FIG. 1 represents a computerized system SYS including a client terminal 1, a service platform 3, and a contents server 8, able to provide a content on request of the client terminal 1. In our exemplary embodiment, the terminal, the platform and the server communicate via an Internet network 2.

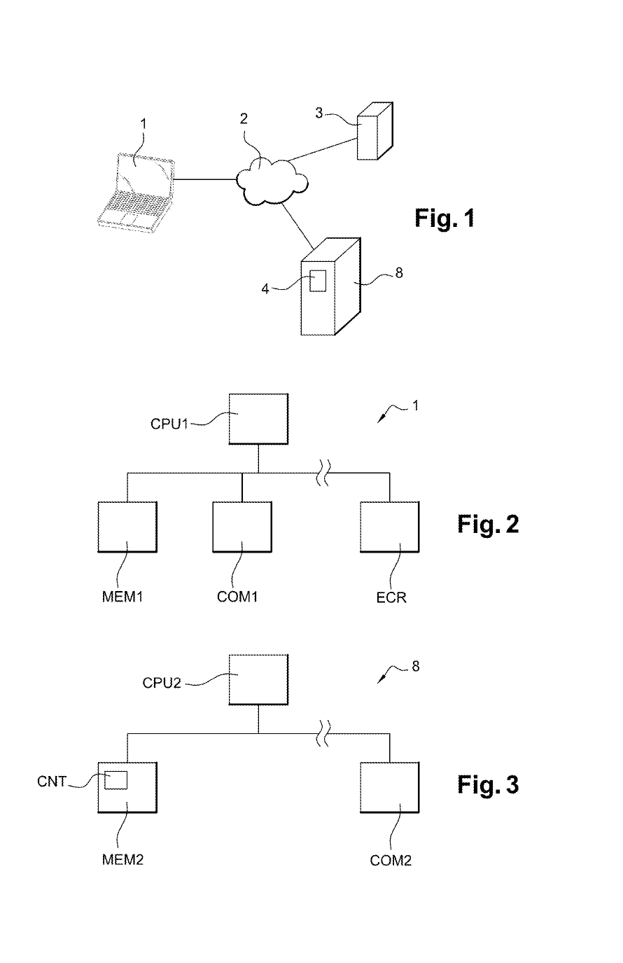

With reference to FIG. 2, the terminal 1 comprises physical and/or software resources, in particular:
a processor CPU1,
a first storage module MEM1,
a playback module such as a screen ECR,
a first communication module COM1 for communicating with the network 2.

The modules described hereinabove as well as the first microprocessor CPU1 are linked together by way of a first bus BUS1.

With reference to FIG. 3, the server 8 comprises
a second processor CPU2,
a second storage module MEM2, storing in particular one or more contents CNT,
a second communication module COM2 for communicating with the network 2.

The second module, included in the server, is linked to the second processor CPU2 by way of a second bus BUS2.

Note that the function of the buses described hereinabove is to ensure the transfer of digital data between the various circuits linked to the microprocessor by a bus. In our example, the bus in question includes a data bus and a control bus.

Note also that, in our example, the memories described hereinabove are write- and read-accessible permanent memories, for example of flash type.

The terminals also include a respective random-access memory (not represented) for storing, in a non-enduring manner, calculation data used during the implementation of a method according to embodiments. These memories are not represented in the drawings since they are not pertinent to the account of the invention.

In our example, the architecture chosen to illustrate the invention is a so-called streaming architecture based on the use of the HTTP protocol. Conventionally, the client terminal (1) wishes to enter into communication with a contents server (8) so as to download a multimedia content composed of one or more media (audio, video, etc.).

Hereinafter in the example, as set forth hereinabove, we adopt a context of streaming according to the MPEG DASH standard.

The terminal (1) interrogates firstly a service platform (3) so as to obtain the address (here, the URL, but more generally, a universal address of URI type) of the description document 4 of the multimedia content (y); hereinafter, this document is a file of MPD type (y.mpd).

The service platform (3) responds by providing the terminal with the address of the file 4; in the example this is the URL “HTTP://x.com/y.mpd” symbolizing a file y of mpd type which can be downloaded from the contents server (8) “x.com”.

An exemplary description file 4 in accordance with the MPEG/DASH standard is presented in annex 1. The relevant fields in the context of the invention, which make it possible in particular to generate the universal addresses, are presented in italics.

The description file 4 makes it possible to generate addresses of media segments.

This construction implements a prior mechanism, described in RFC 3986 mentioned hereinabove, for resolving universal addresses (URI). The client terminal must interpret certain fields and modify them in an appropriate manner to construct the first universal address (URL or URI) of the media segment.

This URI resolution is done according to the element BaseURL, which may be present at various levels of the hierarchy of the file 4.

In this example, the URL addresses are constructed with the aid of the two fields “BaseUrl” (“HTTP://x.com/” and “video/”) and “SegmentTemplate”.

The “SegmentTemplate” specified by the MPEG/DASH standard is a generic method for constructing the intermediate addresses (URI) on the basis of various identifiers, in our example:
$Time$: to be replaced with the start time of the media segment. This time is provided by the “SegmentTimeline” which indicates here an offset of 180180 for each start of new segment;
$Number$: to be replaced with the serial number of the desired media segment;
$Bandwidth$: to be replaced with the value of the “bandwidth” attribute of the targeted representation.

Thus, the first two URL addresses for access to the first two video segments for a quality (or bitrate) of 500 kbps (Kilo Bits per second) are here:
1. HTTP://x.com/video/500000/0.mp4v, and
2. HTTP://x.com/video/500000/180180.mp4v

Note that with one and the same segment there may correspond several possible representations. Here, to each representation there corresponds a respective bitrate. For example,
HTTP://x.com/video/500000/0.mp4v
HTTP://x.com/video/2000000/0.mp4v

are two possible representations of the second segment, one corresponding to a bitrate of 500 kbps, the other to 300 kbps.

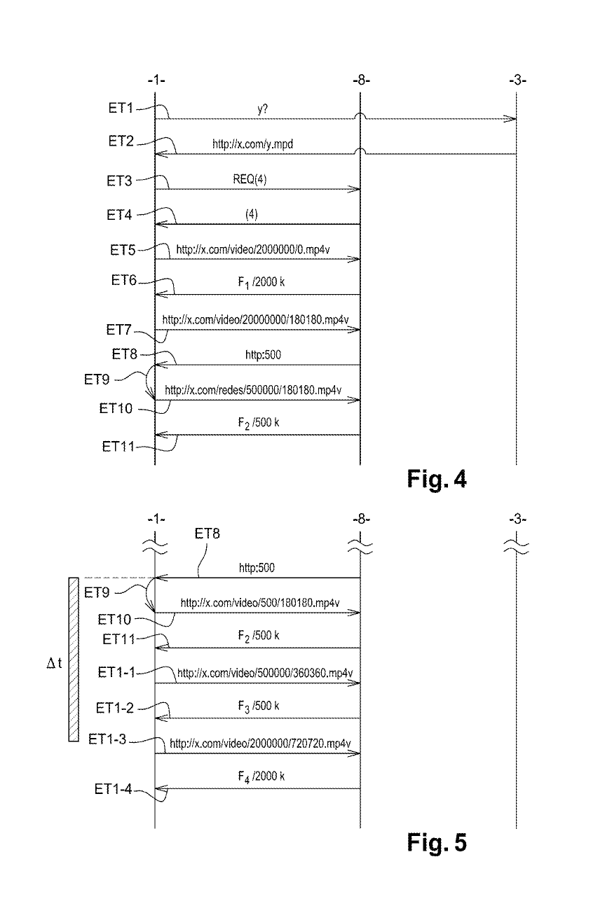

FIG. 4 is a schematic view of the exchanges taking place between the terminal, the platform and the contents server.

It is assumed that the terminal 1 wishes to receive a content (y). It is also assumed that subsequent to the transmission of the second segment, the contents server requests a drop in the encoding bitrate and that the latter is less than 2000 kbps.

During a first step ET1, the terminal 1 interrogates the service platform 3 to obtain the address (here, the URL, but more generally, a universal address of URI type) of the description document 4 of the multimedia content (y); hereinafter, this document is a file of MPD type (y.mpd).

During a second step ET2, the service platform (3) responds by providing the terminal with the address of the file 4, in the example this is the URL

“HTrP://x.com/y.mpd”

symbolizing a content “y” of “mpd” type which can be downloaded from the contents server (8) “x.com”.

During a third step ET3, the terminal requests REQ(4) from the server 8 a downloading of the description file 4.

During a fourth step ET4, the terminal receives and stores the description file 4.

During a fifth step ET5, the terminal (1) accesses the first segment by virtue of the first URL1 described hereinabove:

HTTP://x.com/video/2000000/0.mp4v.

During a sixth step ET6, the server 8 transmits a first data stream F1/2000k, including the first segments. On reception, the terminal can play back the first segments.

During a seventh step ET7, the terminal (1) accesses the second segment by virtue of the second URL2 described hereinabove:

HTTP://x.com/video/2000000/180180.mp4v.

On receipt of the demand for downloading of the second segment, during an eighth step ET8, the server 8 transmits to the terminal 1 a demand for modification of the encoding bitrate. In our example, the demand is included in a distinct message from the data stream including the segments. The demand is illustrated by means of an item of information requesting the terminal for a decrease in the encoding bitrate for this second segment. The information is for example inserted into an error message of http type.

The error message is for example the following:

HTTP/1.1 500 Internal Server Error
Age: 0
Date: Mon, 14 Jan 2013 14:04:43 GMT
Content-Length: 0
Content-Type: video/mp4
Cache-Control: max-age = 7200
Pragma: IISMS/4.0, IIS Media Services by Microsoft
Server: Microsoft-IIS/7.5 IISMS/4.0
bandwidth: 500000

Let us assume that the information in question is a given value of a bitrate, for example 500000 bps. This value can be provided in the error message or deduced by the client terminal from a correspondence base for example stored in the first memory MEM1. In this case, to a code there corresponds not only a demand for modification of the representation but also a given value. In our example, to the value 500 there would correspond the bitrate value of 500 kbps.

During a ninth step ET9, the terminal 1 receives the error message; the terminal interprets the code “500” and deduces therefrom that the message is related to an encoding bitrate modification demand. The terminal also interprets the encoding bitrate decrease/limitation information so as to apply this decrease subsequently.

During a tenth step ET10, the terminal 1 modifies the address so as to access the second segment by taking into account the information received during the sixth step. The resulting new address is therefore in our example: HTTP://x.com/video/500000/180180.mp4v.

The contents server receives the new demand for access to the second segment with an encoding bitrate at 200 kbps.

During an eleventh step ET11, the contents server transmits a data stream F2/500k including the segment with an encoding bitrate at 200 kbps. The terminal thereafter receives the second segment and plays it back.

The method described hereinabove can form the subject of variants.

The information described can take several forms. It can have a fixed value as in the example described hereinabove.

It can also correspond to a maximum value not to be exceeded. In this configuration, assuming that the information indicates that the bitrate must not exceed 1000 kbps, the new address resulting at the eighth step would include a bitrate value of less than 1000 kbps.

In the foregoing example the information is included in an HTTP error message. The Invention is quite obviously not limited to the HTTP protocol but can extend to any other protocols.

The information can also have a limited lifetime Δt. This variant is illustrated in FIG. 5. In this figure, steps ET1 to ET7 (which are not referenced) 14 correspond to those described with reference to FIG. 4. Steps ET8 to ET11 (represented in FIG. 5) are also identical to those described in FIG. 4.

The rest of the steps are referenced ET1-1 to ET1-4.

During step ET1-1, the terminal (1) accesses the third segment. The duration Δt not having expired, the terminal 1 takes account of the bitrate modification demand received at the eighth step ET8 and transmits the request by virtue of the following first URL described hereinabove:

HTTP://x.com/video/500000/360360.mp4v.

During a second step ET1-2, the contents server 8 transmits a third data stream F3/500k including the segment with an encoding bitrate at 500 kbps. The terminal thereafter receives the third segment and plays it back.

During step ET1-3, the terminal (1) accesses the fourth segment. The duration Δt not having expired, the terminal 1 no longer takes account of the bitrate modification demand received at the eighth step ET8. The terminal again consults the description file so as to create the URL address of the fourth segment:

HTTP://x.com/video/2000000/720720.mp4v.

During step ET1-4, the contents server 8 transmits a data stream F3/2000k including segments with an encoding bitrate at 2000 kbps. The terminal 1 thereafter receives the segments and plays them back.

In our example, the error message includes a code, or indeed several codes, indicating the bitrate to be used and the duration Δt during which this bitrate must be taken into account.

On expiry of the duration Δt, the addresses which follow are again based on the description file 4 and on the representations or bitrates initially available initially on the establishment of the session.

It goes without saying that the embodiment which has been described hereinabove has been given purely by way of wholly non-limiting indication, and that numerous modifications can easily be afforded thereto by the person skilled in the art without however departing from the scope of the invention.

Note that for the realization of the method of the invention, the terminal comprises, in addition to the elements described hereinabove with reference to FIG. 2,
a first module for transmitting a request for access to a first segment according to a first chosen representation,
a first module for receiving a response to the request including a demand for modification of the first representation,
a second module for transmitting a request for access to the first segment according to a second representation;
a second module for receiving from the server the first segment according to the second representation.

Note also that for the realization of the method of the invention, the server comprises, in addition to the elements described hereinabove with reference to FIG. 3,
a first module for receiving a request for access to a first segment according to a first chosen representation,
a first module for transmitting a response to the request including a demand for modification of the first representation;
a second module for receiving a request for access to the first segment according to a second representation;
a module for transmitting the first segment according to the second representation.

Note that the term “module” used in this document can correspond either to a software component, or to a hardware component, or else to a set of hardware and/or software components able to implement the function or functions described for the module.

TABLE 1
Example of file 4 of MPD type according to MPEG/DASH
Annex 1

```
<?xml version=“1.0”?>
<MPD
  xmlns:xsi=“HTTP://www.w3.org/2001/XMLSchema-instance”
  xmlns=“urn:mpeg:DASH:schema:MPD:2011”
  xsi:schemaLocation=“urn:mpeg:DASH:schema:MPD:2011 DASH-
  MPD.xsd”
  type=“dynamic”
  minimumUpdatePeriod=“PT2S”
  timeShiftBufferDepth=“PT30M”
  availabilityStartTime=“2011-12-25T12:30:00”
  minBufferTime=“PT4S”
  profiles=“urn:mpeg:dash:profile:isoff-live:2011”>
  <BaseURL>HTTP:// x.com/</BaseURL>
  <Period>
  <!-- Video -->
  <AdaptationSet
    mimeType=“video/mp4”
    codecs=“avc1.4D401F”
    frameRate=“30000/1001”
    segmentAlignment=“true”
    startWithSAP=“1”>
    <BaseURL>video/</BaseURL>
    <SegmentTemplate timescale=“90000” initialization=
“$Bandwidth$/init.mp4 [symbol]  media=“$Bandwidth$/$Time$.mp4v”>
    <SegmentTimeline>
      <S t=“0” d=“180180” r=“432”/>
    </SegmentTimeline>
    </SegmentTemplate>
    <Representation id=“v1” width=“640” height=“480” bandwidth=
    “500000”/>
    <Representation id=“v2” width=“1280” height=“720” bandwidth=
    “2000000”/>
  </AdaptationSet>
  </Period>
</MPD> [symbol]
indicates data missing or illegible when filed
```

1. A method for managing the representation of the data segments (0.mp4v, 180180.mp4v) of a content received by a terminal from a server, the method comprising a step (ET2) of obtaining a document on the basis of which are generated universal addresses, with an address there being associated a representation of the segment concerned, chosen by the terminal from among several representations described in the document, the segment being able to be received from the server according to the chosen representation, characterized in that it comprises the following steps at the level of the terminal,
a first step of transmitting (ET7) a request for access to a first segment according to a first chosen representation,
a first step of receiving (ET8) a response to the request including a demand for modification of the first representation;
a second step of transmitting (ET10) a request for access to the first segment according to a second representation;
a second step of receiving (ET11) from the server the first segment according to the second representation.

2. The management method as claimed in claim 1, characterized in that a representation includes an encoding bitrate value for the segment and in that the first and the second representation include different values.

3. The method as claimed in claim 1, characterized in that the modification of the first representation is taken into account by the terminal for a given duration (Δt).

4. The method as claimed in claim 1, characterized in that the modification demand is transmitted according to the HTTP protocol.

5. A terminal (1) able to receive segments of a content, the terminal having access to a document (4) on the basis of which are generated universal addresses, with an address there being associated a representation of a segment concerned, chosen by the terminal from among several representations described in the document, characterized in that it comprises
a first module for transmitting a request for access to a first segment according to a first chosen representation,
a first module for receiving a response to the request including a demand for modification of the first representation,
a second module for transmitting a request for access to the first segment according to a second representation;
a second module for receiving from the server the first segment according to the second representation.

6. A method of sending, by a server, of segments of a content according to a given respective representation, characterized in that it comprises the following steps:
a first step of receiving a request for access to a first segment according to a first chosen representation,
a first step of transmitting a response to the request including a demand for modification of the first representation;
a second step of receiving a request for access to the first segment according to a second representation;
a second step of sending from the server the first segment according to the second representation.

7. A server (8) able to send segments of a content over a network, characterized in that it comprises
a first module for receiving a request for access to a first segment according to a first chosen representation,
a first module for transmitting a response to the request including a demand for modification of the first representation;
a second module for receiving a request for access to the first segment according to a second representation;
a module for transmitting the first segment according to the second representation.

8. A computer program comprising code instructions which, when the program is executed by a processor, manages the representation of data segments (0.mp4v, 180180.mp4v) of a content received by a terminal from a server, the code instructions comprising a method comprising a step (ET2) of obtaining a document on the basis of which are generated universal addresses, with an address there being associated a representation of the segment concerned, chosen by the terminal from among several representations described in the document, the segment being able to be received from the server according to the chosen representation, characterized in that the method comprises the following steps at the level of the terminal,
a first step of transmitting (ET7) a request for access to a first segment according to a first chosen representation,
a first step of receiving (ET8) a response to the request including a demand for modification of the first representation;
a second step of transmitting (ET10) a request for access to the first segment according to a second representation;
a second step of receiving (ET11) from the server the first segment according to the second representation.

9. A computer program comprising code instructions which, when the program is executed by a processor, sends, by a server, of segments of a content according to a given respective representation, the code instructions comprising a method characterized in that the method comprises the following steps:
a first step of receiving a request for access to a first segment according to a first chosen representation,
a first step of transmitting a response to the request including a demand for modification of the first representation;
a second step of receiving a request for access to the first segment according to a second representation;
a second step of sending from the server the first segment according to the second representation.

10. The computer program as claimed in claim 8, characterized in that a representation includes an encoding bitrate value for the segment and in that the first and the second representation include different values.

11. The computer program as claimed in claim 8, characterized in that the modification of the first representation is taken into account by the terminal for a given duration (Δt).

12. The computer program as claimed in claim 8, characterized in that the modification demand is transmitted according to the HTTP protocol.
